(19) United States
(12) Patent Application Publication
(10) Pub. No.: US 2006/0103893 A1
(43) Pub. Date: May 18, 2006

(54) Cellular telephone based document scanner

(76) Inventors: Kouros Azimi, Center Valley, PA (US); John A. Michejda, Berkeley Heights, NJ (US)

Correspondence Address: MANELLI DENISON & SELTER PLLC., 7th Floor, 2000 M Street, N.W., Washington, DC, 20036-3307, US

(21) Appl. No.: 10/986,811

(22) Filed: Nov. 15, 2004

(51) Int. Cl. H04N 1/04

(52) U.S. Cl. 358/474; 358/501

(57) ABSTRACT

A cellular phone contains a scanner feature for scanning documents directly into a cell phone. The cell phone may scan a small document (e.g., a business card) or a much larger: document (e.g., multiple pages of standard 8½″×11″ paper.). Business card scanning can include a feature to automatically enter data into a contact list, which is then synchronized with a host PC. The particular scanning and stitching methods disclosed in a cell phone are capable of scanning objects that are virtually limitless in size and/or shape, making use of even a low resolution camera integrated into many currently available cell phones. In first embodiments, the disclosed scanner makes use of an external scanner interfaced directly to a digital port of a cell phone, and in second embodiments, the scanner uses a low resolution internal camera to capture images of matrixed portions of a larger object or document.

### BACKGROUND OF THE INVENTION

1. Field of the Invention

This invention relates to wireless devices. In particular, it relates to features and apparatus available in a wireless device such as a cellular phone.

2. Background of Related Art

The world has been transformed by the emergence of wireless devices, and particularly by the proliferation of cellular phones. Virtually everyone has a cell phone, and many users carry them with them as they go about their daily chores.

With increasing processor speeds, more features are being incorporated into cellular phones. For instance, phonebook/address book features that were once the purview of Personal Data Assistants (PDAs) are now basic features of many cell phones available today. Other features include, e.g., cameras designed and integrated into the handset, though generally speaking, such cameras are much lower in resolution than their counterparts in stand-alone, commercially available digital cameras. Yet other features include an external keypad that can be plugged into a digital input port of the cell phone, for manual entry of textual data.

Perhaps just as common as cell phones, or even more so, are personal computers. Personal computers today are the basis for many devices. For instance, photos from a digital camera are often uploaded to a user's personal computer (PC), and then manipulated as necessary and printed through an application running on the PC. Other examples are color printers, FAX machines, and scanners.

The conventional method of scanning a document is well established. A document is scanned by a given scanner device, and stored in an appropriate file type in the host PC. The host PC might then transfer the scanned document to another computer, e.g., as an attachment to an email message through an Internet connection to the computer.

Scanners are commercially available in either a page-feeding format or in a flat-bed format. A page-feeding scanner keeps the scanning optics and sensors stationary, while a page being scanned is passed over the scanning optics at a known speed. A flat-bed scanner maintains the page (or other object) being scanned stationary, while the scanning optics are moved relative to the page or object.

Early scanners were interfaced with a computer using a parallel interface, most often a parallel printer port of the computer. Other early scanners utilized a SCSI port on the computer. Later scanners have made use of high speed serial ports, e.g., USB-1 or USB-2 ports. In any event, scanners are interfaced directly with a personal computer, where an image is initially obtained and stored. Scanned images can be easily emailed or otherwise transmitted to other computers via a modem or network interface, and perhaps an Internet or other network.

Attempts to make scanners more portable usually associate the scanner with a laptop portable computer. However, such portability with a laptop computer comes at a price, as to transmit scanned images from the laptop computer to other computers, the laptop often needs to be plugged into a phone line, and appropriate Internet access software run (e.g., America On Line subscriber service).

While wireless networks are possible with a laptop computer, still a local component of the wireless network (e.g., a gateway computer) must be wired to the public switched telephone network to allow a scanned file to be transmitted to a remote computer.

There is a need for improved scanners and scanning techniques that improve the true portability of the scanner function, as well as improve techniques for obtaining a scanned document within a cell phone.

### SUMMARY OF THE INVENTION

In accordance with the principles of the present invention, a cell phone comprises a cell phone functionality module, and a scanner module. A scanner sensor array is integrated in the cell phone. A processor is in communication with the cell phone functionality module, the scanner module, and the integrated scanner, allowing the cell phone to scan a document.

In accordance with another embodiment, apparatus for scanning a document directly into a cell phone comprises a scanner module operating on a processor in a cell phone, an imaging device, and an image stitching application. The image stitching application stitches together, inside the cell phone, images from a plurality of image files each obtained by the imaging device. A single stitched output image file comprising images from the plurality of image files is stored in memory in the cell phone.

A method of scanning a document directly into a cell phone in accordance with another aspect of the present invention comprises scanning a plurality of image files directly into the cell phone. The plurality of image files are stitched together, in the cell phone, into a single scanned document.

### BRIEF DESCRIPTION OF THE DRAWINGS

Features and advantages of the present invention will become apparent to those skilled in the art from the following description with reference to the drawings, in which:

FIG. 1 is a block diagram showing an exemplary cell phone including a scanner module, in accordance with the principles of the present invention.

FIG. 2 shows a cell phone including a scanner module, together with an external scanner device, in accordance with one embodiment of the present invention.

FIG. 3 shows a cell phone including an internal camera operable with a scanner module, in accordance with another embodiment of the present invention.

FIG. 4 shows a cell phone including a scanner module, mated with a cradle for synchronization with a personal computer, in accordance with the principles of the present invention.

FIG. 5 is a flow chart showing steps of scanning a document with scanning cell phone, in accordance with the principles of the present invention.

FIG. 6 depicts one method of scanning a large document using a low resolution camera integrated with a cell phone, in accordance with aspects of the present invention.

FIG. 7 shows an exemplary clear guide that may be utilized to guide a user in scanning a large document with an internal cell phone camera taking close-up photos of matrix sections, in accordance with the principles of the present invention.

FIG. 8 shows a scanning order for several rows of individual scans, each row including multiple section scans, in accordance with the principles of the present invention.

FIG. 9 depicts an exemplary scanned area for a first section of a first row scanned in FIG. 8.

FIG. 10 shows an exemplary image stitching together of individual scans into separate rows, from the scanning in accordance with that shown in FIG. 8.

FIG. 11 shows a step of image stitching together of separate rows into a complete single scanned image showing the scanned document.

FIGS. 12A and 12B show a cell phone including an integrated scanner element, allowing scanning with the cell phone itself, in accordance with yet another embodiment of the present invention.

### DETAILED DESCRIPTION OF ILLUSTRATIVE EMBODIMENTS

The present invention provides apparatus and a technique for scanning documents directly into a cell phone. The cell phone may scan a small document (e.g., a business card) or a much larger document (e.g., multiple pages of standard 8½″×11″ paper.). Business card scanning can include a feature to automatically enter data into a contact list, which is then synchronized with a host PC. The particular scanning and stitching methods disclosed in a cell phone are capable of scanning objects that are virtually limitless in size and/or shape, making use of even a low resolution camera integrated into many currently available cell phones.

In first embodiments, the disclosed scanner makes use of an external scanner interfaced directly to a digital port of a cell phone, and in second embodiments, the scanner uses a low resolution internal camera to capture images of matrixed portions of a larger object or document.

For instance, once a scanning mode is activated, the user sequentially passes the cell phone camera over the scanned document to capture matrixed portions of a ‘scanned’ image, each initially stored as its own file, into the handset memory.

Note that the images obtained through a round lens of camera produce a slightly rounded, or slightly distorted image, as compared with an image produced by a line of scanner elements each passed over a document as in a conventional scanner. If high resolution scans are necessary and/or desired, distortion correcting filters may be included in the cell phone and applied to captured images at the appropriate time (e.g., after the image is received but before the image is stored).

In the case of a larger object and/or a camera with very low resolution, a series of close-up images may be obtained. Note that the closer the camera is to the image, the larger the rounding distortion will be to the resulting image. Again, a suitable distortion correcting filter tuned to the particular distance the camera is from the object when the picture is taken may be implemented within the cell phone, within the principles of the present invention.

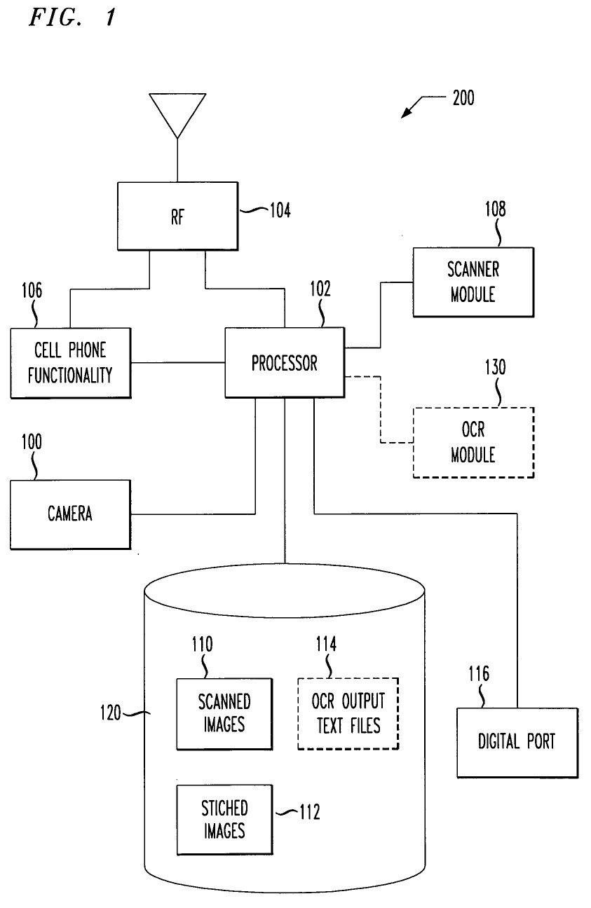

FIG. 1 is a block diagram showing an exemplary cell phone including a scanner module, in accordance with the principles of the present invention.

In particular, FIG. 1 shows a scanning cell phone 200 including a scanner module 108, a processor 102, a radio frequency (RF) front end 104, memory 120, and an otherwise conventional cell phone functionality module 106. The exemplified scanning cell phone 200 further includes a digital port 116, and a camera 100. Optionally, the scanning cell phone 200 may include an optical character recognition (OCR) module 130, and corresponding OCR output text files 114 in the memory 120.

The scanner module 108 is preferably activated by the user while the scanning cell phone 200 is not involved in a telephone call. Moreover, if an incoming telephone call is received while the scanner module 108 is active, the scanner module 108 preferably saves the status quo so that the user may break away from a scanning operation, answer the incoming telephone call, then easily return to the scanning operation with minimal lost effort. Of course, any single scanned image that was in process when the incoming telephone call was received is preferably completed and saved in the memory 120 before pausing to allow active telephone functionality in response to receipt of the incoming telephone call.

One or more applications may be activated after the scanner module 108 obtains a given scan. For instance, an OCR module 130 may be activated to perform optical character recognition on the scanned images, with a corresponding OCR output text file 114 preferably stored in memory 120.

The scanned images obtained by the scanner module 108 may be saved in any appropriate format, e.g., JPEG, TIFF, etc.

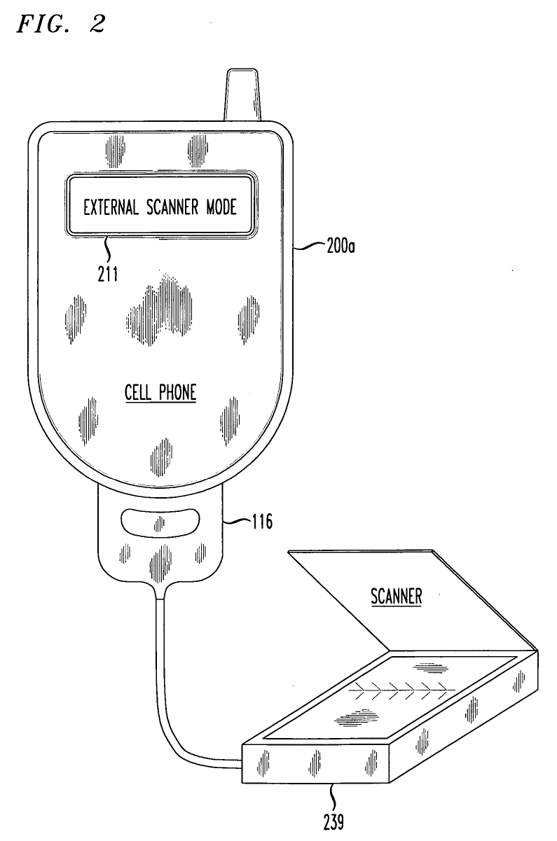

FIG. 2 shows a cell phone including a scanner module, together with an external scanner device, in accordance with one embodiment of the present invention.

In particular, FIG. 2 shows the scanning cell phone 200a activated in an ‘external’ scanner mode, as indicated on the display 211. Of course, the particular scanning mode that the scanning cell phone 200a is in, and in fact whether the scanning cell phone 200a has a scanner module 108 activated so as to operate in a scanning mode at all, may be displayed on any suitable display, inside or outside the cell phone, which in this case is a flip phone style having a display 211 on the outside of the flip case and on the inside (not shown).

In an external scanning mode, an otherwise commercially available scanner 239 is interfaced directly to the scanning cell phone 200a. The interface is made through the digital port 116 of the scanning cell phone 200a. If desired or necessary, a conversion of communications format as between the scanner 239 and the scanning cell phone 200a may be accomplished in an intermediary communications circuit. For instance, a circuit to convert between a standard Universal Serial Bus (USB) format (e.g., USB-1 or USB-2) of the scanner 239 and a customized digital format of the digital port 116. Alternatively, the digital port 116 may be implemented in the scanning cell phone 200a as a common standard interface (e.g., a USB-2 port, RS-232 port, etc.) While the scanner 239 shown in FIG. 2 is a flat bed type scanner, the scanner 239 may be of any suitable form, e.g., sheet feeder, etc.

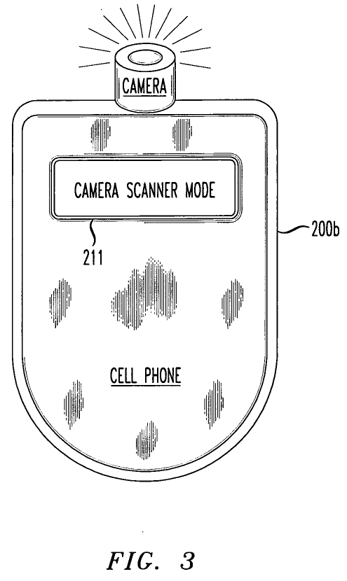

FIG. 3 shows a cell phone including an internal camera operable with a scanner module, in accordance with another embodiment of the present invention.

In particular, FIG. 3 shows that the scanning cell phone 200b may make use of integrated hardware (e.g., a camera 100) to obtain scans of an image.

Oftentimes, a camera 100 in a cell phone is of a generally lower resolution than otherwise available in a stand-alone digital camera device, and certainly less than that of a stand-alone scanner, making scan quality images difficult for large and even just medium sized objects.

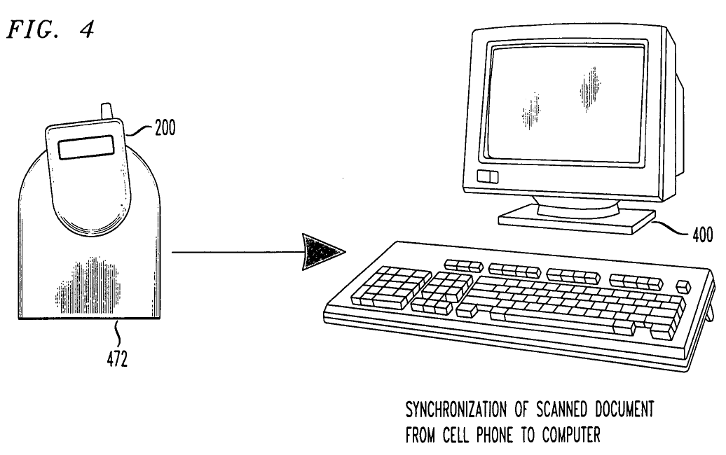

FIG. 4 shows a cell phone including a scanner module, mated with a cradle for synchronization with a personal computer, in accordance with the principles of the present invention.

In particular, FIG. 4 shows that documents and other objects scanned directly into a scanning cell phone 200 may be synchronized with files on a computer 400 in an otherwise conventional fashion, e.g., when the scanning cell phone 200 is placed in its cradle 472, when an infrared port of the scanning cell phone 200 is placed within range of the computer 400, etc.

Note that while a wired synchronization between the cell phone and a PC are shown in FIG. 4, synchronization may be accomplished in any otherwise conventional manner for synchronizing files between a PC and a cell phone. For instance, the cell phone may include an infrared port that has a capability of synchronizing data with the PC using infrared (IR) communications. Other communication mediums may be used for synchronizing between a scanning cell phone 200 and a computer 400, such as use of a BLUETOOTH™ or other wireless Local Area Network (WLAN).

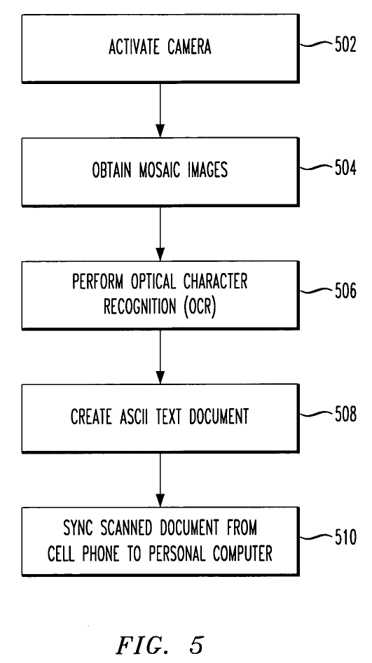

FIG. 5 is a flow chart showing steps of scanning a document with scanning cell phone, in accordance with the principles of the present invention.

In particular, in step 502 of FIG. 5, the camera 100 of a scanning cell phone 200 is activated for use in scanning.

In step 504, one or more mosaic scan images are obtained.

In step 506, after a complete scanned image is stored in the scanning cell phone 200, one or more other application programs may be activated to operate on the scanned images as necessary. For instance, as depicted in FIG. 5, an optical character recognition (OCR) program is run on a scanned image.

In step 508, the OCR program creates an appropriate output file, e.g., an ASCII text document file, and preferably stores the OCR document in its memory 120.

Eventually, and optionally, as shown in step 510 the scanned documents (and/or their derivatives such as OCR-ed ASCII text documents) may be synchronized with a computer.

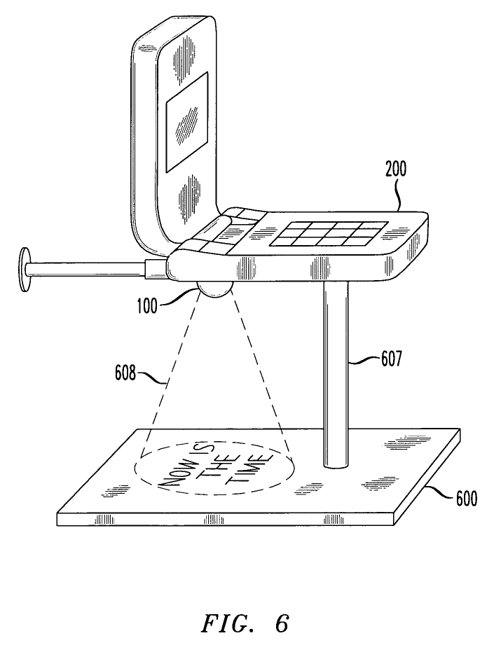

FIG. 6 depicts one method of scanning a large document using a low resolution camera integrated with a cell phone, in accordance with aspects of the present invention.

In particular, FIG. 6 shows an exemplary positioning of a scanning cell phone 200 to utilize its camera 100 for scanning a plurality of separate close-up images to be pieced together by an appropriate panoramic program into a singular scanned document scanned directly into the scanning cell phone 200.

The imaged portion of a document 600 will be limited to a particular region, e.g., as shown by rays 608. To maintain a common distance between the scanned image 600 and the scanning cell phone 200, as physical guide 607 may be implemented. The physical guide may be a wire, plastic, etc. of an appropriate length held between the scanning cell phone 200. Alternatively, or additionally, the antenna itself of the cell phone 200 may be utilized as a distance guide, providing a set distance between the camera 100 and the object being photographed.

Preferably, the camera 100 in the scanning cell phone is capable of a macro mode wherein the camera 100 can focus on images relatively close to its lens, e.g., within a few inches distance.

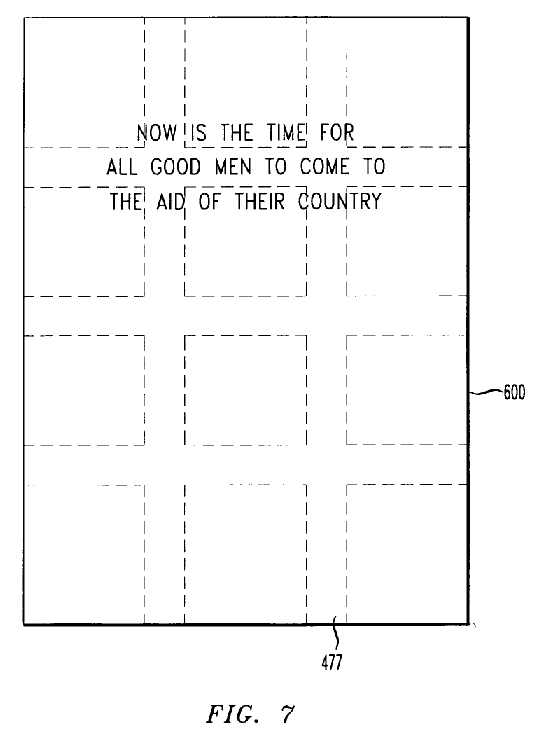

Other guidance may be provided to simplify and/or help guarantee commonality between multiple mosaic images taken of different portions of a same document or other object. For instance, FIG. 7 shows an exemplary clear guide that may be utilized to guide a user in scanning a large document with an internal cell phone camera taking close-up photos of matrix sections, in accordance with the principles of the present invention.

In particular, FIG. 7 shows how a prop 477 such as a translucent grid structure (made from plastic as shown, or even from thin wire) may be utilized to guide a user through a mosaic of lower resolution camera images across a document 600 in a sequential fashion. In the disclosed method, a document 600 is scanned mosaically left to right, then top to bottom. Of course, other directions are also possible (e.g., right to left and/or bottom to top, etc.) so long as such settings are provided in a configuration file or other input to a suitable panorama stitching application program.

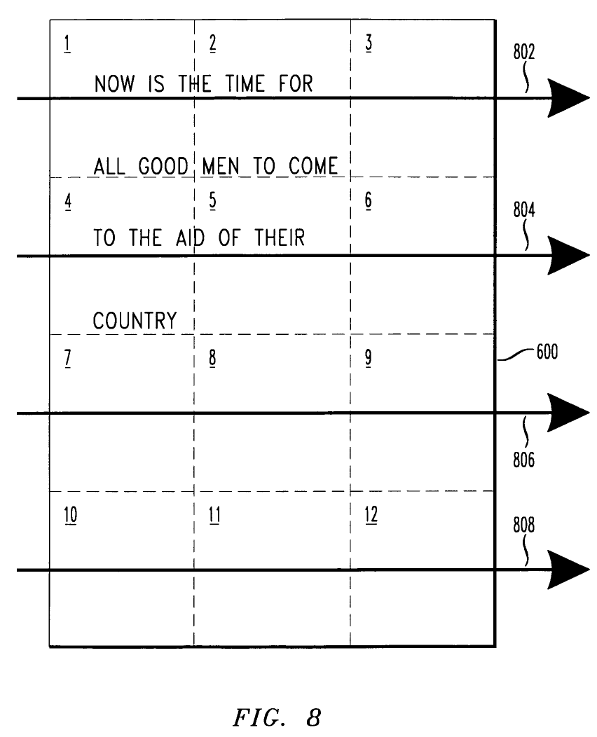

FIG. 8 shows a scanning order for several rows of individual scans, each row including multiple section scans, in accordance with the principles of the present invention.

In particular, FIG. 8 shows scanning of twelve separate mosaic images 1 to 12, from left to right (images 1 to 3), then from top to bottom (row 802 first, then row 804, then row 806, then row 808).

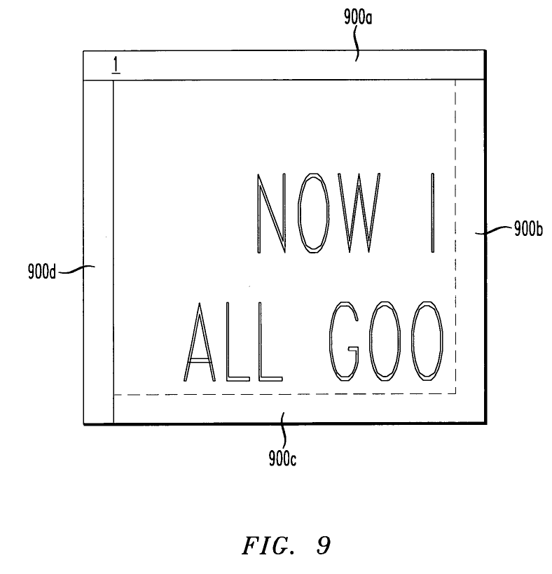

FIG. 9 depicts an exemplary scanned area for a first section of a first row scanned in FIG. 8.

In particular, FIG. 9 shows the mosaic image stored in the memory 120 of the scanning cell phone 200 resulting from a controlled-distance photograph of mosaic image 1 (FIG. 8). Note that text may be partially cut off in the mosaic image 1. Note also that there is preferably overlap 900a to 900d as between adjacent mosaic images, such that the overlapped area 900b will also be photographed by the mosaic image 2, and the overlapped area 900c will also be photographed by the mosaic image 4.

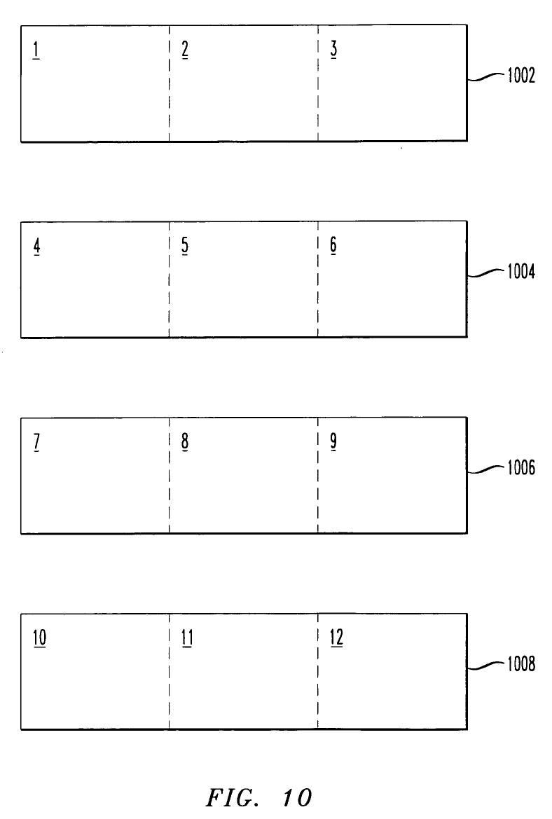

FIG. 10 shows an exemplary image stitching together of individual scans into separate rows, from the scanning in accordance with that shown in FIG. 8.

In particular, FIG. 10 shows the actions of an appropriate panorama forming application program that stitches together adjacent mosaic images. For instance, the first panorama image 1002 formed consists of a stitching together of mosaic images 1, 2 and 3. Similarly, a second panorama image 1004 is formed from mosaic images 4, 5 and 6; a third panorama image 1006 is formed from mosaic images 7, 8 and 9; and a fourth panorama image 1008 is formed from mosaic images 10, 11 and 12.

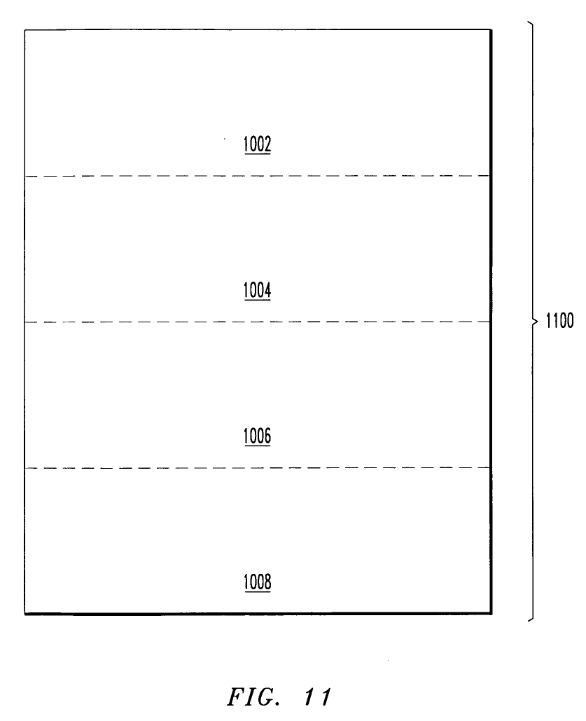

FIG. 11 shows a step of image stitching together of separate rows into a complete single scanned image showing the scanned document.

In particular, FIG. 11 shows a vertical stitching of the first panorama image 1002, second panorama image 1004, third panorama image 1006, and fourth panorama image 1008 into a single scanned image 1100.

Thus, a single scanned image 1100 is stored as a single file in the scanning cell phone 200, and was comprised from a plurality of mosaic image files 1 to 12.

After a desired scan has been made, and the image completely stitched into a single scanned image 1100, the images scanned directly into the scanning cell phone 200 may be used as desired. For instance, any given application may be selected by the user and started acting upon a given scanned image.

As an example application, and as shown in FIG. 1 earlier, an Optical Character Recognition (OCR) application 130 may be activated to convert any typed or written image into computer readable text data (i.e., into ASCII text characters). Then, other applications (such as a word processor) may be activated and operated on the converted text document.

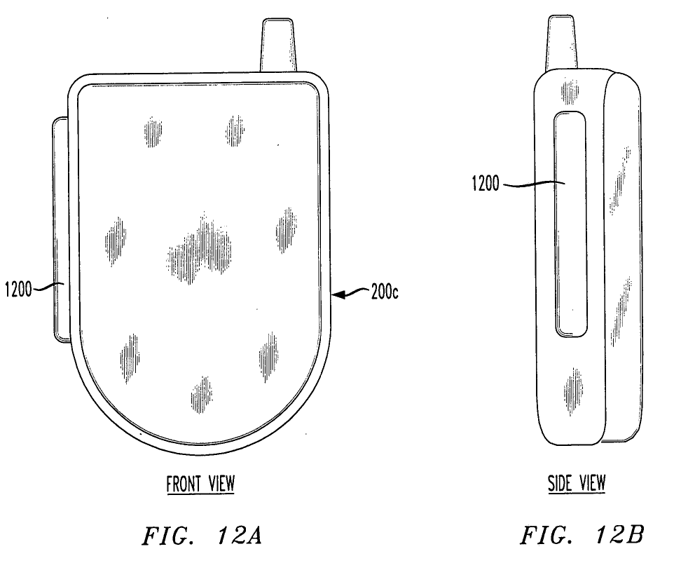

FIGS. 12A and 12B show a cell phone including an integrated scanner element, allowing scanning with the cell phone itself, in accordance with yet another embodiment of the present invention.

In particular, as shown in the front view of FIG. 12A and in the side view of FIG. 12B, a wand-type scanner element 1200 may be integrated within a side, top, bottom, or other surface of the cell phone 200c in such a way as to allow passage of the optical surface of the wand-type scanner 1200 over a scanned object.

The wand-type scanner 1200 preferably includes its own local light source for illuminating a scanned portion of an object being scanned. The user of the cell phone 200c places the wand-type scanner 1200 on an object being scanned, and slowly passes the cell phone 200c across a relevant section of an object being scanned (e.g., a document). When the desired area has been wanded over, the scanner mode of the wand-type scanner 1200 may be deactivated (e.g., by a button press on a side of the cell phone 200c), and removed from the object being scanned. The cell phone 200c is then available for other uses (e.g., for receiving a telephone call.) If a telephone call is received during a scanning operation, the scanning operation may be ended automatically, or the phone call may be refused by the cell phone 200 until the scanning process is completed.

Preferably, the wand-type scanner 1200 is long enough to be passed in a single pass over an average length typed paragraph, e.g., 2″. However, such length is by no way intended to be limiting. Any suitable length scanner element may be implemented so long as it fits in the relevant cell phone 200c.

The wand-type scanner 1200 may be a linear array of optical imaging elements, such as those found in otherwise conventional separate wand scanners. However, importantly, in this embodiment the wand-type scanner 1200 is integrated in the cell phone 200c.

The wand-type scanner 1200 preferably has a fixed focal length appropriate to image an object such as a document placed directly against its optical surface. Separately scanned sections of an object being scanned may be stitched together as otherwise shown, e.g., in FIGS. 7 to 11.

While shown integrated within the cell phone 200c, the wand-type scanner 1200 may be plugged directly into the cell phone 200c such that it makes an integral wired connection therewith. For instance, a wand-type scanner 1200 may be plugged into the digital port 116 of the cell phone 200c. Alternatively, the wand-type scanner 1200 may be formed to have a direct connection into a removable memory card slot in the cell phone 200c.

Other applications that may utilize a scanned image file stored directly on a cell phone (or derivative files thereof such as an ASCII file output from an OCR application) are, for example, an email program that attaches the file and wireless and directly emails the image to another, remote computer directly via a wireless carrier's network. If FAX software is resident in the cell phone, the scanned image might be converted into a FAX signal and transmitted via the carrier's wireless network to a remote FAX machine.

While the invention has been described with reference to the exemplary embodiments thereof, those skilled in the art will be able to make various modifications to the described embodiments of the invention without departing from the true spirit and scope of the invention.

What is claimed is:

1. Apparatus for scanning a document directly into a cell phone, comprising:
a scanner module operating on a processor in a cell phone;
an imaging device; and
an image stitching application;
wherein said image stitching application stitches together, inside said cell phone, images from a plurality of image files each obtained by said imaging device, and stores a single stitched output image file comprising images from said plurality of image files, in memory in said cell phone.

2. The apparatus for scanning a document directly into a cell phone according to claim 1, wherein:
said imaging device is a camera.

3. The apparatus for scanning a document directly into a cell phone according to claim 2, wherein:
said camera is integrated in said cell phone.

4. The apparatus for scanning a document directly into a cell phone according to claim 1, wherein:
said imaging device is an external scanner interfaced directly to said cell phone.

5. The apparatus for scanning a document directly into a cell phone according to claim 4, wherein:
said external scanner is interfaced directly to said cell phone through a wired port.

6. The apparatus for scanning a document directly into a cell phone according to claim 4, wherein:
said external scanner is interfaced directly to said cell phone through an infrared port.

7. The apparatus for scanning a document directly into a cell phone according to claim 1, wherein:
said image stitching application is a panorama stitching program.

8. The apparatus for scanning a document directly into a cell phone according to claim 1, wherein:
said memory in said cell phone is a removable memory card in said cell phone.

9. The apparatus for scanning a document directly into a cell phone according to claim 1, wherein said plurality of images comprise:
a scanned business card.

10. The apparatus for scanning a document directly into a cell phone according to claim 1, wherein said plurality of images comprise:
a sheet of 8½″×11″ sized paper.

11. The apparatus for scanning a document directly into a cell phone according to claim 1, wherein said plurality of images comprise:
a sheet of A4 sized paper.

12. A method of scanning a document directly into a cell phone, comprising:
scanning a plurality of image files directly into said cell phone; and
stitching together, in said cell phone, said plurality of image files into a single scanned document.

13. The method of scanning a document directly into a cell phone according to claim 12, further comprising:
activating a camera for scanning said plurality of image files directly into said cell phone.

14. The method of scanning a document directly into a cell phone according to claim 13, wherein:
said camera is integrated in said cell phone.

15. The method of scanning a document directly into a cell phone according to claim 12, further comprising:
activating an external scanner for scanning said plurality of image files directly into said cell phone.

16. The method of scanning a document directly into a cell phone according to claim 15, wherein:
said external scanner is interfaced directly to said cell phone through a wired port.

17. The method of scanning a document directly into a cell phone according to claim 15, wherein:
said external scanner is interfaced directly to said cell phone through an infrared port.

18. The method of scanning a document directly into a cell phone according to claim 12, wherein:
said plurality of image files are stored in a removable memory card in said cell phone.

19. The method of scanning a document directly into a cell phone according to claim 12, wherein said plurality of images comprise:
a scanned business card.

20. The method of scanning a document directly into a cell phone according to claim 12, wherein said plurality of images comprise:
a sheet of 8½″×11″ sized paper.

21. Apparatus for scanning a document directly into a cell phone, comprising:
means for scanning a plurality of image files directly into said cell phone; and
means for stitching together, in said cell phone, said plurality of image files into a single scanned document.

22. The apparatus for scanning a document directly into a cell phone according to claim 21, wherein said means for scanning comprises:
a camera.

23. The apparatus for scanning a document directly into a cell phone according to claim 22, wherein:
said camera is integrated in said cell phone.

24. The apparatus for scanning a document directly into a cell phone according to claim 21, further comprising:
means for storing said plurality of image files into a removable memory card in said cell phone.

25. The apparatus for scanning a document directly into a cell phone according to claim 21, wherein said plurality of image files comprise:
a scanned business card.

26. The apparatus for scanning a document directly into a cell phone according to claim 21, wherein said plurality of image files comprise:
a sheet of 8½″×11″ sized paper.

27. A cell phone, comprising:
a cell phone functionality module;
a scanner module;
a scanner sensor array in integral connection with said cell phone; and
a processor in communication with said cell phone functionality module, said scanner module, and said integrated scanner, allowing said cell phone to scan a document.

28. The cell phone according to claim 27, wherein:
a scanned image of said document is stored in memory in said cell phone.

29. The cell phone according to claim 28, wherein:
said memory in said cell phone includes a removable memory card removable from said cell phone.

30. The cell phone according to claim 27, wherein:
said scanner includes a self-illuminating source for lighting an object being scanned.

31. The cell phone according to claim 27, wherein:
said scanner is a wand-type scanner.
